(19) United States
(12) Patent Application Publication
(10) Pub. No.: US 2020/0096900 A1
(43) Pub. Date: Mar. 26, 2020

(54) APPARATUS HAVING CAPABILITY OF RECEIVING AUTOMATIC ORDER SERVICE OF CONSUMABLE PRODUCTS AND THE LIKE, CONTROL METHOD THEREOF AND STORAGE MEDIUM

(71) Applicant: CANON KABUSHIKI KAISHA, Tokyo (JP)

(72) Inventor: Akihiro Moriya, Kashiwa-shi (JP)

(21) Appl. No.: 16/566,443

(22) Filed: Sep. 10, 2019

(30) Foreign Application Priority Data
Sep. 25, 2018 (JP) 2018-179266

(51) Int. Cl. G03G 15/08; H04M 3/42; G03G 15/00

(52) U.S. Cl. CPC G03G 15/0863; G03G 15/55; G03G 15/0865; H04M 3/42374

(57) ABSTRACT

To provide a mechanism to improve convenience of a user who uses an automatic order service of consumer products and the like. An apparatus having a capability of receiving a consumable product automatic order service acquires first information indicating presence/absence of registration for using the automatic order service. Then, in a case where access information on a site relating to the consumable product is output based on the acquired first information, access information on a site different between a case where registration to the automatic order service is completed and a case where registration is not completed is output.

### BACKGROUND OF THE INVENTION

### Field of the Invention

The present invention relates to a technique to provide information to a user who uses an apparatus that needs to exchange consumable products and the like in order to maintain the apparatus performance and the like.

### Description of the Related Art

In an image forming apparatus that performs printing on a sheet and the like by using color materials, a variety of consumable products exist, such as cartridges containing color materials, printing sheets, and conveyance rollers. Further, in a case of an electrophotographic image forming apparatus, developing devices, electrifying devices, photoconductor drums, and the like also correspond to the consumable products, and it is necessary to purchase and exchange those units as needed. In order to simplify time and effort of a user relating to purchase of those consumable products, there is a case where a vendor or the like prepares a service of automatically ordering a consumable product to a predetermined order destination.

The mechanism of the consumable product automatic order service as described above is in general such that, for example, a cartridge is automatically ordered in a case where the color material remaining amount becomes less than or equal to a predetermined threshold value. At this time, in order to prevent an automatic order contrary to the intention of a user from being made, a technique to proceed with the purchase after, for example, the user him/herself checks the remaining amount of a consumable product has been proposed (Japanese Patent Laid-Open No. 2010-61694).

Further, in view of that it is not necessary for a user to take care of the remaining amount of a color material in a case where the user has subscribed to the consumable product automatic order service, a technique to determine timing of a notification of the consumable product remaining amount in accordance with the state of subscription to the service has also been proposed (Japanese Patent Laid-Open No. 2017-65155).

In a case where a user uses the consumable product automatic order service described above, provision of various kinds of information that recommends a user to purchase a consumable product, for example, guidance to an on-line shopping site or to a site that recommends over-the-counter purchase, is not necessary for the user and is rather troublesome. With the technique of the above-described Japanese Patent Laid-Open No. 2010-61694, it is possible to prevent the consumable product automatic order contrary to the intention of a user, but it is not possible to suppress the unnecessary information provision such as this. Further, only by changing the timing of a notification of the consumable product remaining amount as in the technique of Japanese Patent Laid-Open No. 2017-65155, for example, in a case where a user forgets having subscribed to the automatic order service, there is a possibility that the user erroneously purchases the consumable product in accordance with guidance (duplicate order).

The present invention has been made in view of the above-described problems and an object is to provide a mechanism to improve convenience of a user who uses an automatic order service of consumable products and the like.

### SUMMARY OF THE INVENTION

The apparatus according to the present invention is an apparatus having a capability of receiving a consumable product automatic order service and including: an acquisition unit configured to acquire first information indicating presence/absence of registration for using the automatic order service; and an output unit configured to output access information on a site displaying information relating to the consumable product based on the first information acquired by the acquisition unit, and the output unit outputs access information on a site that is different between a case where registration to the automatic order service is completed and a case where registration is not completed.

Further features of the present invention will become apparent from the following description of exemplary embodiments with reference to the attached drawings.

### BRIEF DESCRIPTION OF THE DRAWINGS

FIG. 1 is a block diagram showing an example of a configuration of a system that implements a consumable product automatic order service;

FIG. 2 is a diagram showing an example of a software configuration of an SFP;

FIG. 3A is a diagram showing a software configuration of an information management server and FIG. 3B is a diagram showing a software configuration of a PC;

FIG. 4A is an outer appearance diagram of an operation unit and FIG. 4B to FIG. 4D are each a diagram showing an example of a UI screen;

FIG. 5 is a flowchart showing a flow of output processing of a consumable product status report;

FIG. 6 is a diagram showing an example of service registration information;

FIG. 7 is a diagram showing an example of information stored in an access destination DB;

FIG. 8 is a diagram showing an example of a consumable product status report;

FIG. 9A is a diagram showing an example of a cartridge automatic order service screen and FIG. 9B is a diagram showing an example of a cartridge purchase reception screen;

FIG. 10 is a flowchart showing a flow of processing for an SFP to acquire and store service registration information;

FIG. 11 is a diagram showing an example of a remote UI screen; and

FIG. 12 is a flowchart showing a flow of processing to directly access information relating to arrangements for consumable products and the like from a PC via a WEB browser.

### DESCRIPTION OF THE EMBODIMENTS

Hereinafter, with reference to the attached drawings, the present invention is explained in detail in accordance with preferred embodiments. Configurations shown in the following embodiments are merely exemplary and the present invention is not limited to the configurations shown schematically.

### FIRST EMBODIMENT

### System Configuration and Hardware Configuration

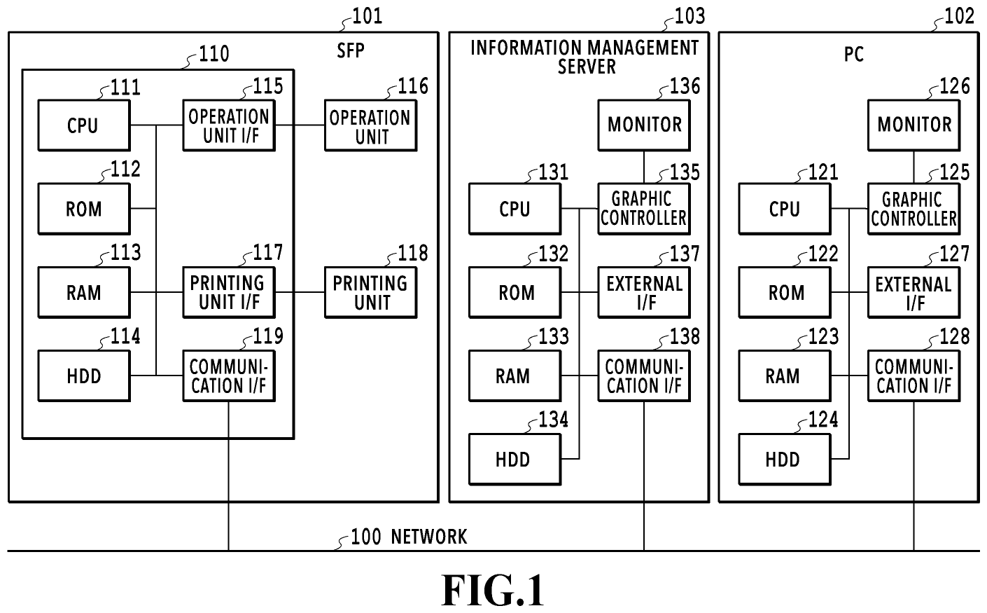

FIG. 1 is a block diagram showing an example of the configuration of a system that implements a consumable product automatic order service according to the present embodiment. The system shown in FIG. 1 includes an SFP (Single Function Printer) 101, which is an electrophotographic image forming apparatus, a PC 102, which is an information processing apparatus, and an information management server 103 and these are connected so as to be capable of communication via a network 100, such a LAN. In the present embodiment, explanation is given by taking a case as an example where cartridges containing color materials (toner) used in the SPF 101 specialized in the print function are registered to the automatic order service. However, the article that is the target of the automatic order service is not limited to cartridges and may be, for example, printing sheets, conveyance rollers, and the like. Further, the target apparatus is not limited to the SFP and may be an MFP (Multi Function Printer) including a plurality of functions, such as the scan function, in addition to the print function. In the case such as this, for example, rollers or pads of the scan mechanism may be the target article of the automatic order service. Further, the target apparatus may be a so-called post-processing apparatus (finisher apparatus including the staple function and the punch function for a printout document) not having the print function. In a case of the post-processing apparatus, what is the target of the automatic order service is staples for exchange on a condition that the apparatus is an apparatus that performs stapling processing, recovery boxes of punch chips on a condition that the apparatus is an apparatus that bores a punch hole, and the like. Further, the target apparatus may be an apparatus having no relation with printing processing and may be any apparatus as long as for which the service of automatically ordering maintenance items for maintaining the apparatus performance or for exhibiting the original function and usage of the apparatus is prepared by a vendor or the like. That is, any apparatus that needs to exchange or replenish consumable products or articles used for maintenance management regularly or irregularly may widely be a target

The configuration of the system is not limited to this and for example, the number of PCs 102 may be two or more. Further, for example, the SFP 101 may also include the function of the information management server 103.

First, the hardware configuration of the information management server 103 is explained. The information management server 103 includes a CPU 131, a ROM 132, a RAM 133, an HDD 134, a graphic controller 135, a monitor 136, an external I/F 137, and a communication I/F 138 and these are connected so as to be capable of communication via a bus. The CPU 131 includes a computing circuit and centralizedly controls the information management server 103. The CPU 131 reads programs stored in the ROM 132 or the HDD 134 onto the RAM 133 and performs various kinds of processing. The ROM 132 stores a system program and the like. The RAM 133 is used as a work area of the CPU 131. The graphic controller 134 generates a UI screen that is displayed on the monitor 135. The HDD 134 as a large-capacity storage device stores various application programs, data, and the like. In place of the HDD, an SSD (Solid State Drive) or the like may be used. The external I/F 137 connects a keyboard, a mouse, and the like via an external I/F. The communication I/F 138 is an interface for communicating with the SFP 101 and the PC 102.

Next, the hardware configuration of the PC 102 is explained. The PC 102 is an information processing apparatus as a client terminal capable of accessing the SFP 101 via the network 100 and the basic hardware configuration is the same as that of the information management server 103 described above. That is, the PC 102 includes a CPU 121, a ROM 122, a RAM 123, an HDD 124, a graphic controller 125, a monitor 126, an external I/F 127, and a communication I/F 128 and each component is connected so as to be capable of communication via a bus. It is possible for the PC 102 to cause the SFP 101 to perform printing processing by transmitting a print job.

Next, the hardware configuration of the SFP 101 is explained. The SFP 101 is an image forming apparatus specialized in printing processing. A control unit 110 including a CPU 111 controls the operation of the entire SFP 101. The CPU 111 reads control programs stored in a ROM 112 or an HDD 114 and performs printing control and the like. The ROM 112 stores control programs executed by the CPU 111. A RAM 113 is a main storage memory of the CPU 111 and is used as a temporary storage area for loading various control programs stored in the ROM 112 and the HDD 114. The HDD 114 as a large-capacity storage device stores print jobs, various programs, various pieces of setting information, and the like. An operation unit I/F 115 is an interface that connects an operation unit 116 and the control unit 110. The operation unit 116 includes, for example, a touch panel display and hard keys and is used for a user to give various instructions and perform setting. A printing unit I/F 117 is an interface that connects a printing unit 118 and the control unit 110. The printing unit 118 receives a print command and print data via the control unit 110 and prints an image on a sheet (printing medium) based on the print data. The sheet also includes a plastic sheet and the like, other than paper. The printing method of the printing unit 118 is the electrophotographic method in the present embodiment, but the printing method is not limited to this. For example, another method, such as an ink jet method, may be adopted. In a case of the electrophotographic method, after forming an electrostatic latent image on a photoconductor, the electrostatic latent image is developed by toner, the toner image is transferred onto a sheet, and an image is formed by fixing the transferred toner image. A cartridge filled with toner is attached to the inside of the SFP 101 detachably. In a case where the toner within the cartridge runs short, a user exchanges the cartridge with a new cartridge. The CPU 111 acquires information indicating the use situation of the cartridge at predetermined timing, such as once a day, each time one page is printed, and at the time of attachment of a cartridge and stores the acquired information in the RAM 113 or the like. Here, the information indicating the use situation of a cartridge includes the cartridge serial number, the toner color, the capacity, the maker name, and the like, in addition to the toner remaining amount. In the present embodiment, the toner remaining amount is explained by the percentage representation, but the level representation, for example, such as Normal and Low, may be adopted. The basic information, such as the cartridge serial number, is stored in the RAM 113 or the like at the time of attachment. In the present embodiment, the target article of the automatic order service is cartridges, and therefore, the toner remaining amount within a cartridge is acquired and stored. In a case where the target article of the automatic order service is printing sheets or conveyance rollers, for example, information capable of estimating the amount used or the degree of wear, for example, such as the number of printing-processed sheets (number of sheets passed), is acquired and stored.

Further, the control unit 110 is connected to the network 100 via a communication I/F 119. The communication I/F 119 acquires information indicating whether or not the SFP 101 is registered as the target product of the cartridge automatic order service (whether a user has subscribed to the service) from the information management server 103 on the network 100. Further, the communication I/F 119 receives a print job from the PC 102, transmits the above-described cartridge information stored in the RAM 113 or the like to the PC 102, and so on. The print job received via the communication I/F 119 is analyzed by a software module (PDL analysis unit, not shown schematically) for analyzing PDL data included in a print job. The PDL analysis unit interprets PDL data represented in a page description language and generates print data to be supplied to the printing processing in the printing unit 118. Further, the communication I/F 119 provides information on a remote operation screen to be displayed on the monitor 126 of the PC 102 to the PC 102 via the network 100.

### Software Configuration

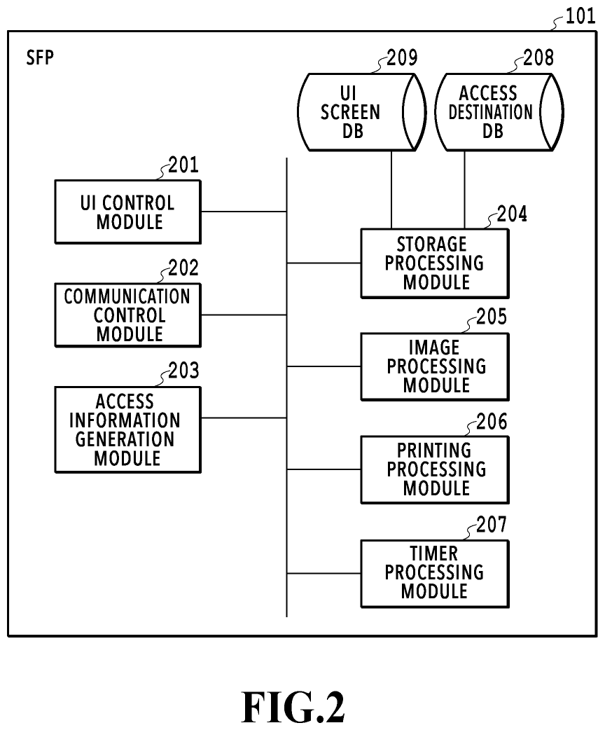

FIG. 2 is a diagram showing an example of the software configuration of the SFP 101. Each function module shown in FIG. 2 is implemented by the CPU 111 within the SFP 101 executing a predetermined control program. A UI control module 201 performs display control and input reception control at the operation unit 116 via the operation unit I/F 115. Specifically, the UI control module 201 displays information necessary for a user, alternatives, and the like on a display, receives an input operation by a user, notifies another function module of the contents thereof, and so on. A communication control module 202 controls connection/disconnection of a network, such as a LAN, and transmission and reception of data and commands via the communication I/F 119. An access information generation module 203 generates an access destination URL, to be described later. A storage processing module 204 stores specified data in the ROM 112, the RAM 113, and the HDD 114 in accordance with instructions from another function module, reads data stored in those units, and so on. An image processing module 205 generates and modifies print data to be supplied to the printing processing in the printing unit 118 based on the print job received from the PC 102 or the like. A printing processing module 206 controls the printing processing in the printing unit 118 by sending out various control commands to the printing unit 118 via the printing unit I/F 117, performing monitoring of the state of the printing unit 118, and so on. A timer processing module 207 performs time count processing and determines whether or not a predetermined time has elapsed. An access destination DB 208 is a database storing access information for a user to access information relating to a cartridge for exchange. A UI screen DB 209 is a database storing data of various user interface screens and the data of a remote operation UI screen used in a second embodiment is also stored here.

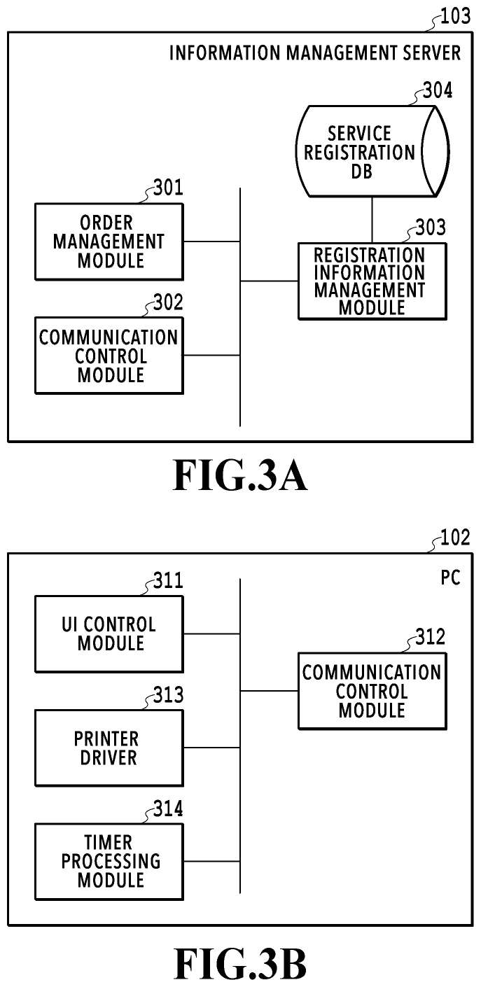

FIG. 3A is a diagram showing the software configuration of the information management server 103 and FIG. 3B is a diagram showing the software configuration of the PC 102. Each function module shown in FIG. 3A and FIG. 3B is implemented by the CPU 131 or 121 executing a predetermined control program.

First, the software configuration of the information management server 103 is explained. An order management module 301 refers to cartridge information on the SFP 101, which is received via the communication I/F 137, at the time of registration of the cartridge automatic order service and performs order processing of a cartridge in a case where the toner remaining amount becomes less than or equal to a predetermined threshold value (for example, 10%). The predetermined threshold value is set to an arbitrary value by a user at the time of service contract, or the like. A communication control module 302 controls connection/disconnection of the network 10, such as a LAN, and transmission and reception of data and commands via the communication I/F 138. A registration information management module 303 refers to the service registration information stored in a service registration DB 304 in response to an inquiry (polling) from the SFP 101 and returns whether the SFP 101 is registered as the target of the cartridge automatic order service to the SFP 101. It is assumed that for the automatic order service, prior registration is performed in a variety of units (for example, in units of users, in units of apparatuses, in units of offices).

Next, the software configuration of the PC 102 is explained. As shown in FIG. 3B, the PC 102 has two modules and one driver. A UI control module 311 controls the monitor 126 via the graphic controller 125. In the second embodiment, the UI control module 311 performs display control at the time of a user checking purchase information on a consumable product and the like by remote access via a WEB browser. A communication control module 312 controls connection/disconnection of the network 100, such as a LAN, and transmission and reception of data and commands via the communication I/F 128. A printer driver 313 boots in a case where a user gives instructions to print document data and the like from various applications (not shown schematically) and performs various kinds of setting relating to the printing processing using the SFP 101, in addition to generation of a print job. In a print job, PDL data obtained by converting document data relating to printing instructions of a user into a page description language that the SFP 101 can interpret is included and the generated print job is sent to the SPF 101 via the network 100. The printer driver 313 is installed in the PC 102 at the time of registration of the SFP 101 and the printer driver 313 grasps the printers that the printer driver 313 itself supports. That is, in a case where printers of different models are connected on the network, printer drivers in accordance with each model are installed in the PC 102. A timer processing module 314 performs time count processing and determines whether or not a predetermined time has elapsed like the timer processing module 207 of the SFP 101.

In the software configuration described above, highly relevant modules for explanation of the present invention are enumerated and modules are not limited to those modules and another module, not shown schematically, may also be included.

### Local UI of SFP

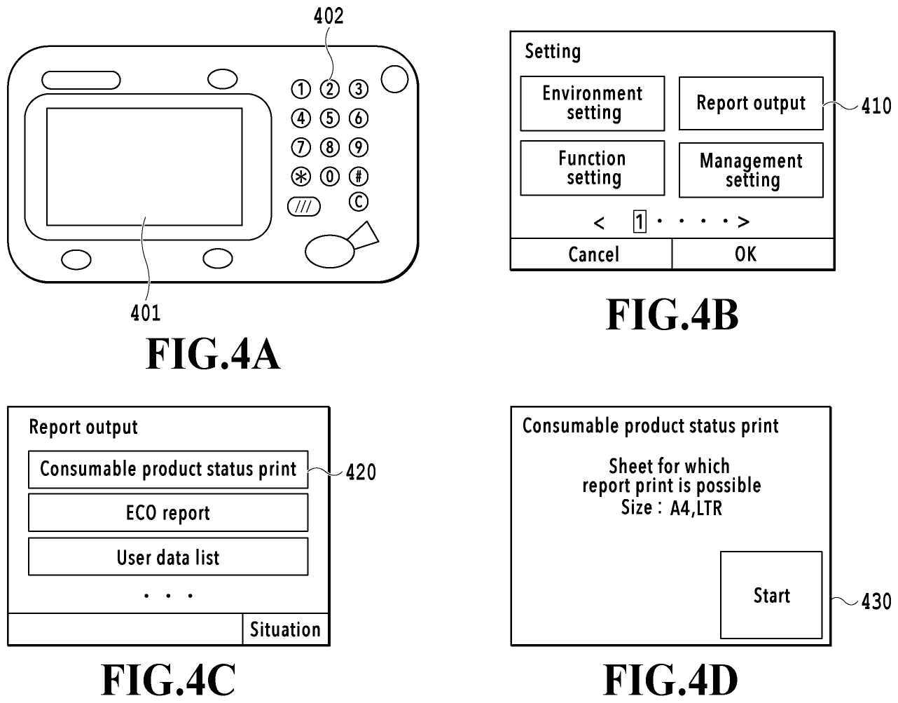

FIG. 4A is an outer appearance diagram of the operation unit 116. The operation unit 116 includes a display 401 and a hard key input unit 402. As described previously, the display 401 is a touch panel display and displays a UI screen, to be described later, and receives a user operation for the UI screen. The hard key 402 includes a ten-key unit configured to input a numerical value, and the like. A user inputs desired instructions by touching a key button displayed on the display 401 or pressing down the hard key 402.

FIG. 4B to FIG. 4D each show an example of a UI screen that is displayed on the above-described display 401. A user gives instructions to output a report for accessing information relating to arrangements and purchase of a cartridge, which is a consumable product, through the UI screen displayed on the display 401. FIG. 4B is a UI screen for performing various kinds of setting in the SFP 101. In a case where a “Report output” button 410 is pressed down on the UI screen in FIG. 4B, the UI screen makes a transition into a UI screen shown in FIG. 4C. In a case where a user presses down a “Consumable product status print” button 420 on the UI screen in FIG. 4C, the UI screen further makes a transition into a UI screen shown in FIG. 4D. Then, in a case where a “Start” button 430 is pressed down on the UI screen in FIG. 4D, output of a report (consumable product status report) is performed, which describes an address of a site for a user to check the order situation/shipment situation of a cartridge for exchange or make a purchase of a cartridge.

### Output Processing of Consumable Product Status Report

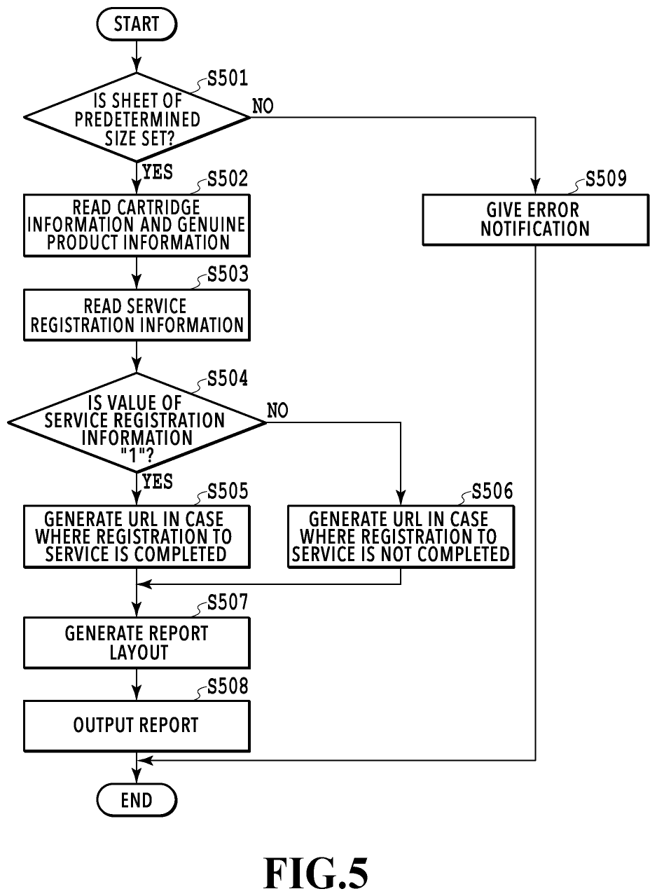

FIG. 5 is a flowchart showing a flow of the output processing of the consumable product status report described above according to the present embodiment. It is assumed that each operation (step) of the flowchart shown in FIG. 5 is implemented by the CPU 111 loading a control program stored in the ROM 112 or the HDD 114 onto the RAM 113 and executing the control program. Further, it may also be possible to cause, for example, a plurality of CPUs and RAMs to cooperate to perform this. Furthermore, it may also be possible to perform part of the processing by using a hardware circuit, such as ASIC and FPGA. Execution of this flow is started in a case where a user operation to give instructions to print the consumable product status is detected by the UI control module 201. In the following explanation, “S” represents a step.

At S501, the printing processing module 206 determines whether or not a sheet of a predetermined size (for example, A4 or LTR) is set in the feed cassette. In a case where a sheet of a predetermined size is not set, the processing advances to S509. At S509, the UI control module 201 gives an error notification to the effect that the printing processing cannot be performed. After the completion of the error notification, this processing is terminated. In a case where a sheet of a predetermined size is set, the processing advances to S502.

At S502, the storage processing module 204 reads the cartridge information described above and genuine product information (information on the name, model number, and the like of the genuine cartridge). As described previously, as the cartridge information, the information that is acquired regularly or irregularly by the CPU 111 and stored in the RAM 113 or the like is read. As the genuine product information, the information that is set and stored in the ROM 112 or the HDD 114 at the time of shipment, installation, or the like of the SFP 101 is read.

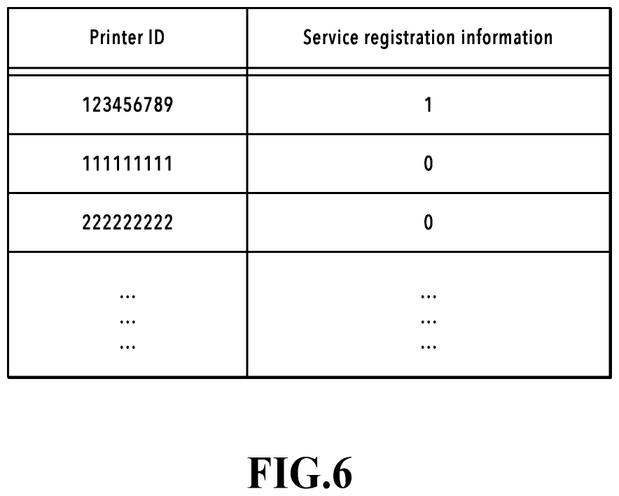

At S503, the storage processing module 204 reads the service registration information described above from the RAM 113 or the HDD 114. FIG. 6 is a diagram showing an example of the service registration information. In the service registration information in FIG. 6, “Printer ID” that uniquely identifies the SFP 101 and “Service registration information” that indicates the situation of registration to the cartridge automatic order service by two values, that is, “1 (registered)” and “0 (unregistered)” are stored in association with each other. Here, it is assumed that the printer ID of the SFP 101 is “123456789”. The value of the service registration information corresponding to this is “1”, and therefore, the SFP 101 is registered as the target printer of the cartridge automatic order service. This service registration information is managed in the information management server 103 and the SFP 101 acquires the service registration information from the information management server 103 by, for example, polling and stores in the RAM 113 or the HDD 114. Processing to acquire the service registration information from the information management server 103 and store in the RAM 113 or the like will be explained with reference to another flow. Here, the value of the service registration information is taken to be “1” or “0”, but the values are not limited to those and it is needless to say that the number of patterns increases in accordance with the number of services to be provided.

At S504, based on the service registration information read at S503, the processing to which the processing advances next is branched. Specifically, in a case where the value of the service registration information is “1”, the processing advances to S505 and in a case of “0”, the processing advances to S506.

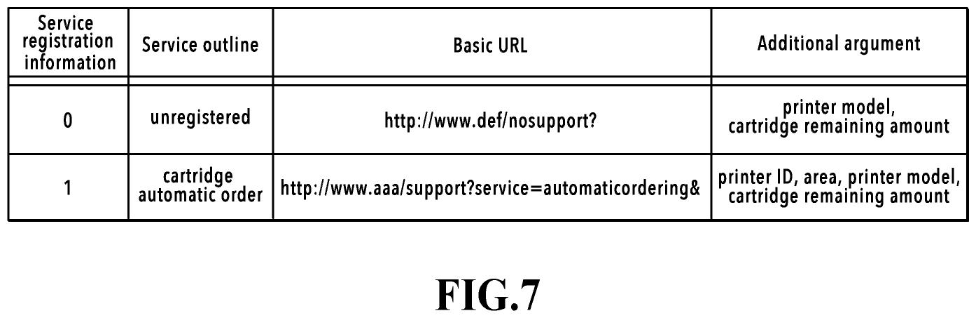

At S505, by the access information generation module 203, an access destination URL in view of that the SFP 101 is registered to the cartridge automatic order service is generated. At this time, the access destination DB 208 is referred to via the storage processing module 204. FIG. 7 is a diagram showing an example of information stored in the access destination DB 208 and “Service outline”, “Basic URL”, and “Additional argument” are stored in association with the service registration information. In FIG. 7, the basic URL corresponding to a case where the value of the service registration information is “1” is “http://www.aaa/support?service=automaticordering&” and the additional arguments are four of “printer ID”, “area”, “printer model”, and “toner remaining amount”. The basic URL is determined by, for example, the registration information management module 303 based on the service registration information. Here, the additional argument refers to the argument that completes the access destination URL, which is added to the basic URL. The access destination URL that is generated in a case where the value of the service registration information is “1” is, for example, as follows.
http://www.aaa/support?service=automaticordering&id=123456789&locale=jp&model=F900&Y=low&M=ok&C=ok&BK=out

In the above-described access destination URL, “id=123456789” corresponds to “printer ID”, “locale=jp” corresponds to “area”, “model=F900” corresponds to “printer model”, and “Y=low&M=ok&C=ok&BK=out” corresponds to “toner remaining amount”, respectively.

At S506, by the access information generation module 203, an access destination URL in view of that the SFP 101 is not registered to the cartridge automatic order service is generated. That is, by using the basic URL “http://www.def/nosupport?” corresponding to a case where the value of the service registration information is “0” and the two additional arguments “printer model” and “toner remaining amount”, for example, an access destination URL as follows is generated.
http://www.def/nosupport?model=F900&Y=low&M=ok&C=ok&BK=out

At S507, the image processing module 205 generates report output print data (report layout) by using the access destination URL generated at S505 or S506. After this, at S508, the printing processing module 206 performs printing processing in accordance with the report layout generated at S507 and outputs the consumable product status report.

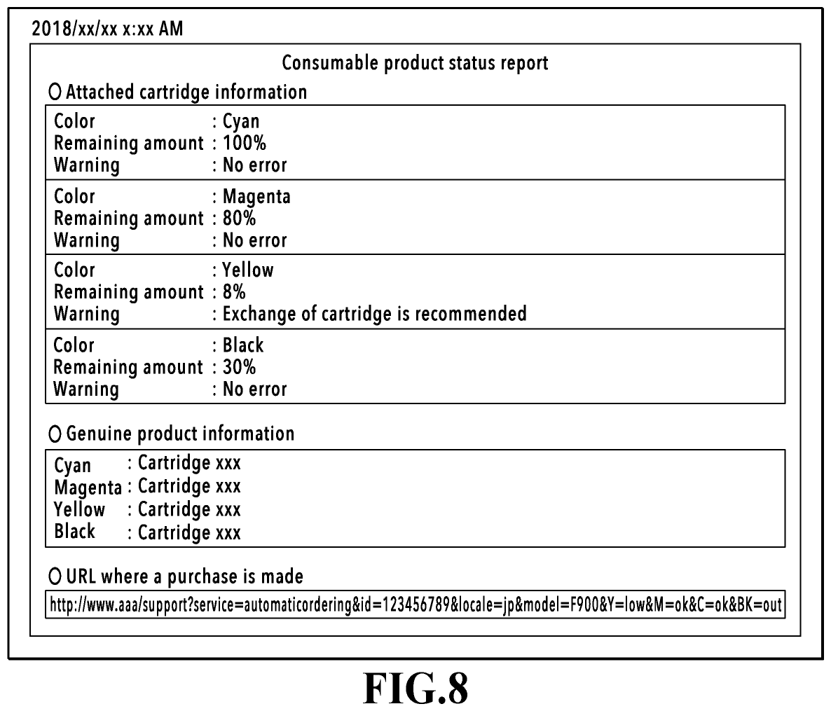

The above is the contents of the consumable product status report output processing. FIG. 8 shows an example of the consumable product status report. Information on the toner remaining amount of each cartridge attached to the SFP 101, information on the model number and the like of the genuine product, and information on the URL where the cartridge is purchased are described. Then, in “URL where a purchase is made”, the access destination URL generated at S505 or S506 is described. It is made possible for a user to acquire information relating to a cartridge for exchange by accessing the site from an information equipment terminal, such as the PC 102, based on the URL described in the report.

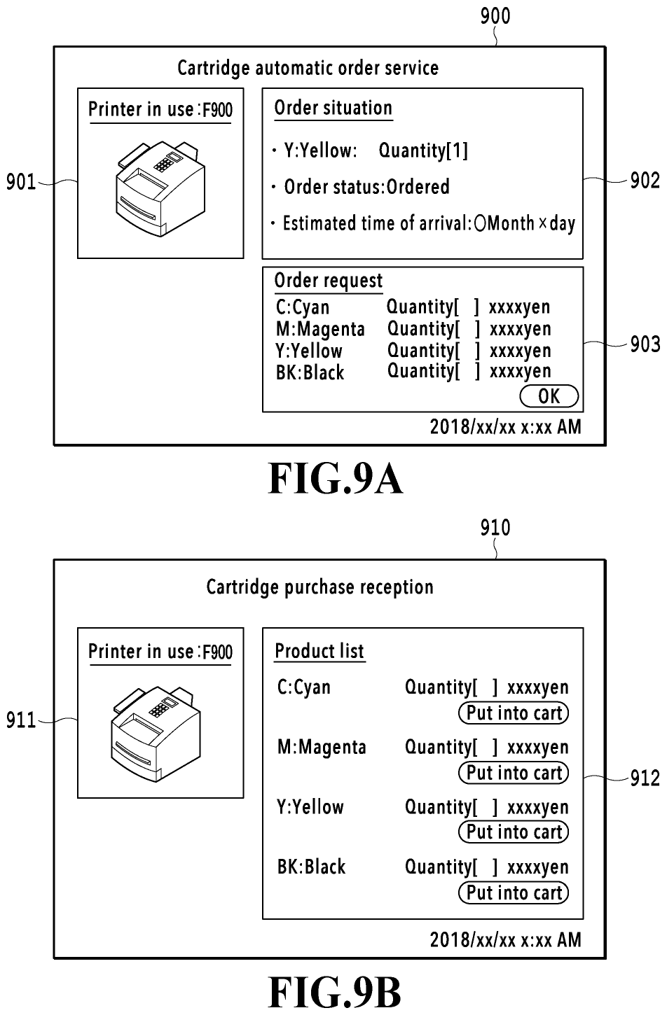

FIG. 9A and FIG. 9B are each an example of a page screen that is displayed on a monitor or the like in a case where a user accesses a site by using a URL described in the consumable product status report from the PC 102 or the like. A screen 900 in FIG. 9A is a page screen (cartridge automatic order service screen) corresponding to the access destination URL in a case where a user has subscribed to the cartridge automatic order service. The cartridge automatic order service screen 900 includes a model display area 901, an order situation display area 902, and an order request reception area 903. In the example of the consumable product status report shown in FIG. 8, of the cartridges mounted on the SFP 101, yellow (Y) indicates “Remaining amount: 8%”. At this time, by the order management module 301 of the information management server 103, the automatic order processing of a yellow (Y) cartridge is performed and a message “Ordered” indicating this fact is displayed in the order situation display area 902. It may also be possible to display information on the shipment situation in the order situation display area 902 in place of (or in addition to) the order situation. Further, in the order request reception area 903, it is also possible for a user to order a cartridge at his/her discretion and in a case where a user specifies a desired cartridge and presses down an “OK” button, the cartridge is sent to the address registered as the destination of a cartridge at the time of the prior registration.

A screen 910 in FIG. 9B is a page screen (cartridge purchase reception screen) corresponding to the access destination URL in a case a user has not subscribed to the cartridge automatic order service. The cartridge purchase reception screen 910 includes a model display area 911 and a product list display area 912. The model display area 911 is the same as the model display area 901 on the UI screen 900 described above. In the product list display area 912, in accordance with the toner remaining amount of each cartridge at the current point in time, the predicted necessary number of cartridges for each cartridge is displayed. For example, in the example of the consumable product status report shown in FIG. 8, of the four cartridges mounted on the printing unit 118 of the SFP 101, yellow (Y) is “Remaining amount: 8%”. Consequently, it is determined that the possibility that a user orders a yellow (Y) cartridge is strong, and therefore, the number of cartridges corresponding to the Y cartridge is displayed as “1”. As described above, by determining the access destination URL that is described in the consumable product status report in accordance with the situation of subscription to the cartridge automatic order service, it is made possible to guide a user to an appropriate information site.

### Acquisition/Storage of Service Registration Information

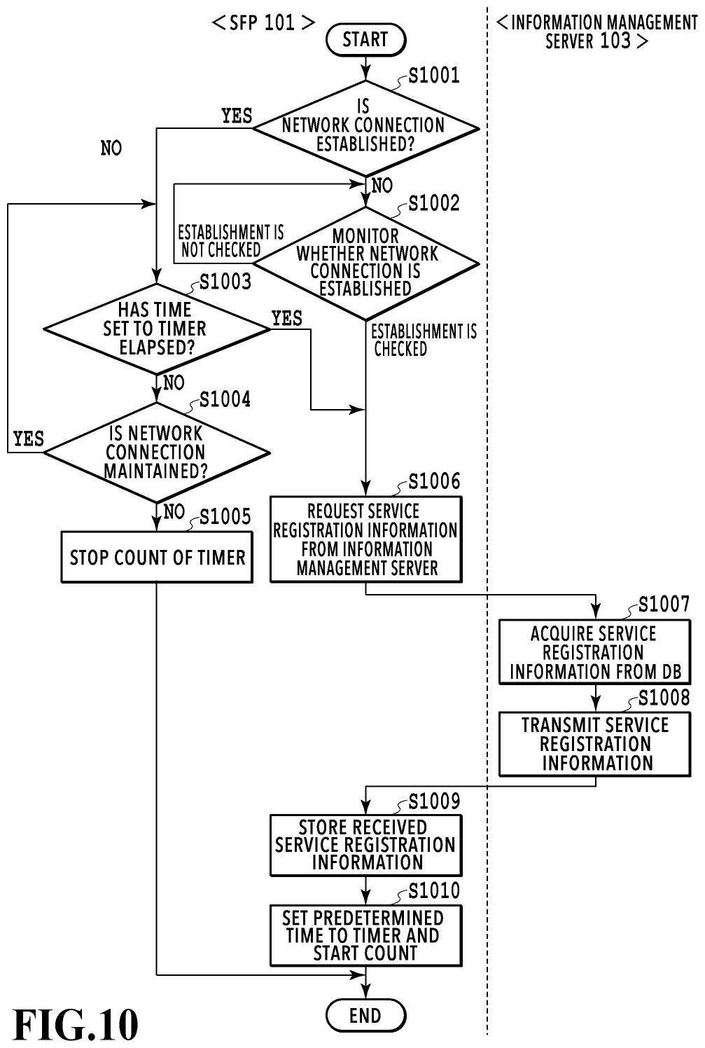

FIG. 10 is a flowchart showing a flow of processing for the SFP 101 to acquire and store service registration information from the information management server 103 by polling. Of each operation (step) of the flowchart shown in FIGS. 10, S1001 to S1006, S1009, and S1010 are performed on the side of the SFP 101 and S1007 and S1008 are performed on the side of the information management server 103. In the following explanation, “S” represents a step.

First, at S1001, whether network correction is established with the information management server 103 is determined. The LAN control module 202 monitors the state of connection to the network 100 and at this step, processing is branched in accordance with the connection state. In a case where the network connection is established, the processing advances to S1003 and in a case where the network connection is not established, the processing advances to S1002.

At S1002, monitoring is continued until network connection is established. In a case where establishment of network connection is checked, the processing advances to S1006. On the other hand, at S1003, whether a predetermined time specifying a polling interval that is set to a timer has elapsed is determined. The predetermined time will be described later. In a case where the predetermined time has elapsed, the processing advances to S1006 and in a case where the predetermined time has not elapsed yet, the processing advances to S1004. Then, at S1004, whether the network connection is maintained is checked and in a case where the network connection is maintained, the processing returns to S1003 and in a case where the network connection is disconnected, the processing advances to S1005. At S1005, the count operation in the above-described timer is stopped. After the stop of the count operation of the timer, this processing is exited. At S1006, the information management server 103 is accessed via the communication I/F 119 and at the same time, a request to acquire service registration information is transmitted. Along with the acquisition request, the printer ID of the SFP 101 is also sent.

At S1007, in the information management server 103, in response to the acquisition request from the SFP 101, the service registration information associated with the printer ID of the SFP 101 is read from the service registration DB 304 by the registration information management module 303. At S1008 that follows, the read service registration information is transmitted to the SFP 101.

At S1009, in the storage processing module 204 of the SFP 101, the service registration information received from the information management server 103 is stored in the HDD 114. Then, at S1010, in the timer processing module 207, a predetermined time specifying the polling interval for acquiring the service registration information is set to the timer and the count operation is started. The predetermined time at this time is arbitrary, and in a case where the service registration information is acquired, for example, each time 24 hours elapse, ‘86,400 (sec)” is set.

The above is the contents of the processing to acquire and store the service registration information from the information management server 103 by polling.

### Modification Example

In the present embodiment, the example is explained in which the access destination URL itself is described in the consumable product status report, but the example is not limited to this. For example, it may also be possible to describe a two-dimensional code, such as a QR code (registered trademark), linked with the access destination URL. In this case, generation of a QR code is performed in the access information generation module 203.

Further, it may also be possible to give a notification to a user by describing the access destination URL (or two-dimensional code linked therewith) on the UI screen that is displayed on the operation unit 116 in place of the report output. Furthermore, in a case of an apparatus, such as an MFP, having a comparatively large operation display with a high definition, it may also be possible to directly display the page screen corresponding to the determined access destination URL as shown in FIG. 9A and FIG. 9B described previously on the operation display thereof.

In a case where registration to the service is completed, it may also be possible to display a message to the effect that a user has subscribed to the automatic order service of consumable products and the like in place of the access destination URL for guiding a user to the site as shown in FIG. 9A.

According to the present embodiment, in accordance with the presence/absence of the registration to the automatic order service of consumable products and the like, such as cartridges of color materials in the printing apparatus, the address information on the information site relating to arrangements and purchase of the consumable products and the like is determined and a user is notified of this. Due to this, it is possible to guide a user to an appropriate information site in accordance with the situation of registration to the automatic order service.

### SECOND EMBODIMENT

The first embodiment 1 is the aspect in which a user accesses the purchase site of consumable products and the like anew from the PC 120 with reference to the report and the like by printing and outputting the report and the like on which the access destination URL is described by operating the SFP 101. Next, an aspect is explained as the second embodiment in which a user directly accesses the information site relating to arrangements of consumable products and the like from the SFP 101 by a remote UI from the PC 102. Explanation of the portions in common to those of the first embodiment, such as the system configuration, is simplified or omitted and in the following, points unique to the present embodiment are explained mainly.

### Remote UI of PC

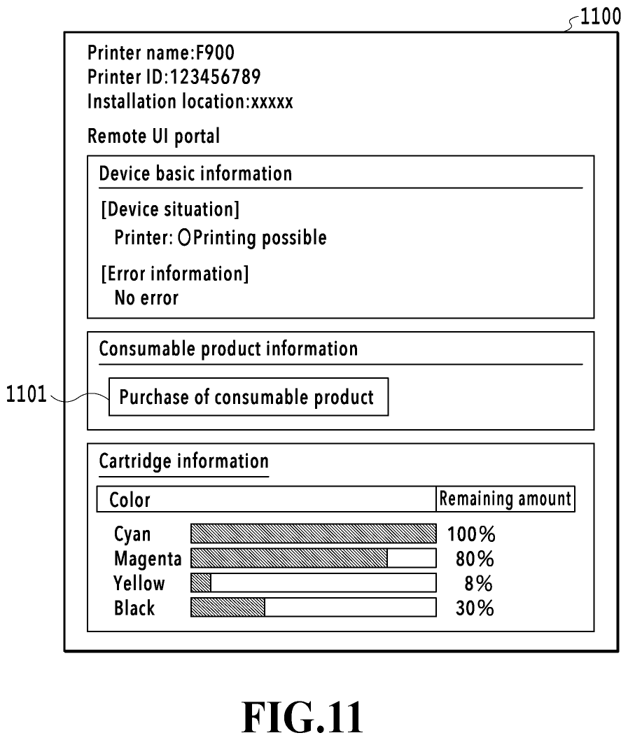

FIG. 11 shows an example of a UI screen for remote access (remote UI screen) that is displayed on the monitor 126. A remote UI screen 1100 is, for example, a screen in the html format that can be displayed by a WEB browser and the like and provided from the SFP 101 by instructions from the printer driver 313 and displayed on the monitor 126 by the UI control module 311.

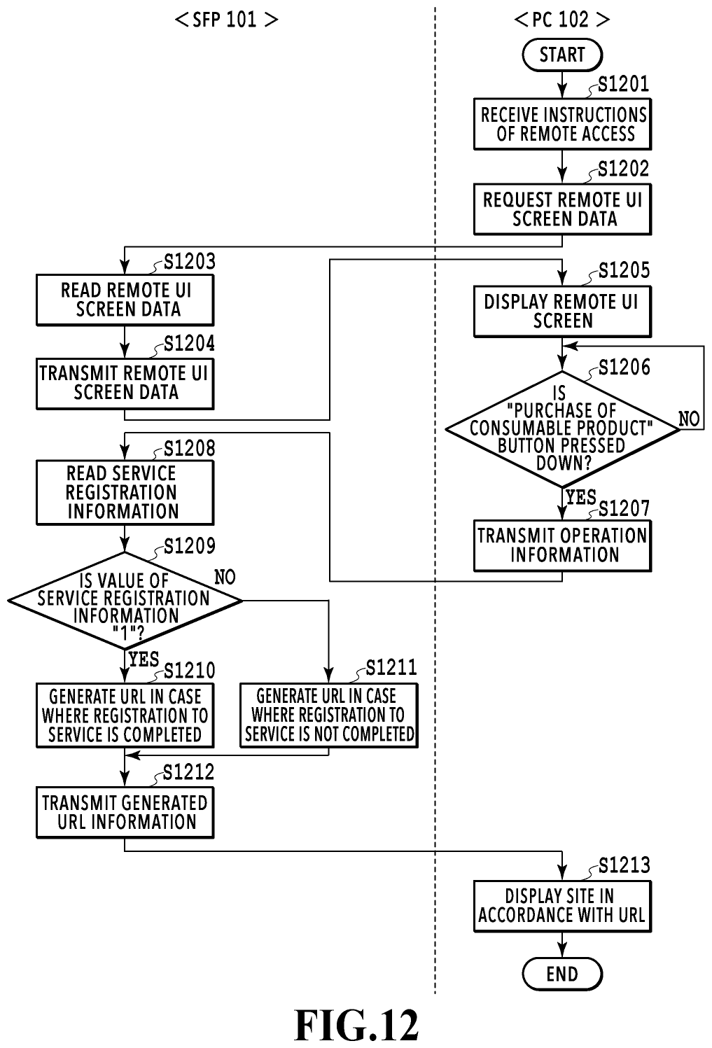

FIG. 12 is a flowchart showing a flow of processing to directly access information relating to arrangements of consumable products and the like by the remote UI from the PC 102 according to the present embodiment. Of each operation (step) of the flowchart shown in FIGS. 12, S1201, S1202, S1205 to S1207, and S1213 are performed on the side of the PC 102 and S1203, S1204, and S1208 to S1212 are performed on the side of the SFP 101. Then, it is assumed that each of these steps is implemented by the CPU loading the control program stored in the ROM or the HDD onto the RAM and executing the program in each of the PC 102 and the SFP 101. In the following explanation, “S” represents a step.

First, at S1201, user instructions of remote access are received via the printer driver 313 of the PC 102. Upon receipt of the instructions, at S1202 that follows, the SFP 101 is requested for the data of the remote UI screen 1100 described above.

At S1203, in response to the above-described request, the data of the remote UI screen 1100 is read from the UI screen DB 209 by the storage processing module 204 of the SFP 101. At S1204 that follows, the read data of the remote UI screen 1100 is transmitted to the PC 102.

At S1205, in the PC 102 having received the above-described data, the remote UI screen 1100 is displayed on the monitor 126 by the UI control module 311. Then, in a case where pressing down of a “Purchase of consumable product” button 1101 within the remote UI screen 1100 is detected at S1206, the operation information is transmitted to the SFP 101 at S1207.

At S1208, in the SFP 101 having received the above-described operation information, the service registration information is read from the RAM 113 or the HDD 114 by the storage processing module 204. At S1209 that follows, as in the case with S504 of the flow in FIG. 5 of the first embodiment, based on the service registration information read at S1208, the processing to which the processing advances next is branched. Specifically, in a case where the value of the service registration information is “1”, the processing advances to S1201 and in a case where the value is “0”, the processing advances to S1211.

At S1210, as in the case with S505 described previously, an access destination URL in view of that registration to the cartridge automatic order service is completed is generated. Further, at S1211, as in the case with S506 described previously, an access destination URL in view of that registration to the cartridge automatic order service is not completed is generated. Then, at S1212, the information on the generated access destination URL information is transmitted to the PC 102 by the communication control module 202.

At S1213, in the PC 102 having received the information on the above-described access destination URL, the UI control module 311 displays the page screen (see FIG. 9A and FIG. 9B) of the site in accordance with the access destination URL by a WEB browser. In this manner, it is made possible for a user to browse an appropriate site in accordance with the situation of registration to the consumable product automatic order service from the PC 102, which is the client terminal.

As above, according to the present embodiment, even in a case where a user directly accesses an information site relating to arrangements and purchase of consumable products and the like by remote access from the PC 102, it is made possible to guide the user to an appropriate site in accordance with the situation of registration to the consumable product automatic order service.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According the present invention, it is possible to provide appropriate information to a user in accordance with the state of subscription to the automatic order service of consumable products and the like, and therefore, convenience of the user improves.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-179266, filed Sep. 25, 2018 which is hereby incorporated by reference wherein in its entirety.

What is claimed is:

1. An apparatus having a capability of receiving a consumable product automatic order service, the apparatus comprising:
an acquisition unit configured to acquire first information indicating presence/absence of registration for using the automatic order service; and
an output unit configured to output access information on a site displaying information relating to the consumable product based on the first information acquired by the acquisition unit, wherein
the output unit outputs access information on a site that is different between a case where registration to the automatic order service is completed and a case where registration is not completed.

2. The apparatus according to claim 1, wherein
the output unit outputs:
access information on a site including information on an order situation or a shipment situation of the consumable product in a case where registration to the automatic order service is completed; and
access information on a site for purchasing the consumable product in a case where registration to the automatic order service is not completed.

3. The apparatus according to claim 1, wherein
the apparatus is connected with a server via a network, which manages the first information and
the acquisition unit acquires the first information from the server.

4. The apparatus according to claim 1, wherein
the access information is address information on a site.

5. The apparatus according to claim 1, wherein
the access information is a two-dimensional code linked with address information on a site.

6. The apparatus according to claim 1, wherein
the acquisition unit further acquires second information indicating a use situation of the consumable product and
the output unit outputs the second information along with the access information.

7. The apparatus according to claim 1, wherein
the apparatus has a printing unit configured to perform printing processing and
the output unit performs the output by performing printing on a printing sheet by the printing processing.

8. The apparatus according to claim 1, wherein
the apparatus has a display unit configured to display a UI screen and
the output unit performs the output by displaying the access information on the UI screen.

9. The apparatus according to claim 7, wherein
the consumable product is a consumable product used in printing processing.

10. The apparatus according to claim 9, wherein
the consumable product is one of a cartridge containing a color material, a printing sheet, and a conveyance roller.

11. An information processing apparatus that is connected to an apparatus via a network, which has a capability of receiving a consumable product automatic order service, the information processing apparatus comprising:
an acquisition unit configured to acquire access information on a site relating to the consumable product via the network, which is generated based on information indicating presence/absence of registration for using the automatic order service; and
a display unit configured to display a site indicated by the access information acquired by the acquisition unit, wherein
a site indicated by the access information is different between a case where registration to the automatic order service is completed and a case where registration is not completed.

12. A control method of an apparatus having a capability of receiving a consumable product automatic order service, the control method comprising the steps of:
acquiring first information indicating presence/absence of registration for using the automatic order service; and
outputting access information on a site relating to the consumable product based on the first information acquired at the acquisition step, wherein
at the output step, access information on a site different between a case where registration to the automatic order service is completed and a case where registration is not completed is output.

13. A control method of an information processing apparatus that is connected to an apparatus via a network, which has a capability of receiving a consumable product automatic order service, the control method comprising the steps of:
acquiring access information on a site relating to the consumer product via the network, which is generated based on information indicating presence/absence of registration for using the automatic order service; and
displaying a site indicated by the acquired access information, wherein
a site indicated by the access information is different between a case where registration to the automatic order service is completed and a case where registration is not completed.

14. A non-transitory computer readable storage medium storing a program for causing a computer to perform a control method of an information processing apparatus that is connected to an apparatus via a network, which has a capability of receiving a consumable product automatic order service, the control method comprising the steps of:
acquiring access information on a site relating to the consumer product via the network, which is generated based on information indicating presence/absence of registration for using the automatic order service; and
displaying a site indicated by the acquired access information, wherein
a site indicated by the access information is different between a case where registration to the automatic order service is completed and a case where registration is not completed.
